(19) United States
(12) Patent Application Publication
(10) Pub. No.: US 2023/0298431 A1
(43) Pub. Date: Sep. 21, 2023

(54) COMPUTER-OPERATED PERCENTAGE-BASED LOTTERY SYSTEM AND METHOD

(71) Applicant: Jeryl Carter, Oak Ridge, NC (US)

(72) Inventor: Jeryl Carter, Oak Ridge, NC (US)

(21) Appl. No.: 17/698,649

(22) Filed: Mar. 18, 2022

(51) Int. Cl. G07F 17/32

(52) U.S. Cl. CPC G07F 17/3232; G07F 17/329

(57) ABSTRACT

An Internet-based, computer-operated, and percentage-based lottery system and method operated by multiple users utilizing an electronic computing device, wherein each of the plurality of users input user-identifying information, a user-desired wagering amount, a user-desired winning percentage, of one of the plurality of varying winning percentages, and a user-desired number of participants, of one of the varying defined limits of participants, to form at least one user lottery pool having the user-desired number of participants therein and randomly selecting a number of lottery winners from the at least one user lottery pool based on the user-desired winning percentage and the user-desired wagering amount.

### FIELD OF THE INVENTION

The present invention relates generally to Internet-based gaming methods carried out by multiple users over a network, and, more particularly, a network-based percentage-based lottery system and method operated by multiple users utilizing an electronic computing device.

### BACKGROUND OF THE INVENTION

Different methods have been used to increase interest in instant-win lottery tickets. Methods such as increasing payout prizes, adding new locations to purchase tickets, and even electronic scratch-off tickets have been presented. However, traditional lottery systems have always randomly picked their winners. See, e.g., Safaei et al. (Scientific Games International, Inc.), U.S. Pat. No. 8,696,431 B2 (Apr. 15, 2014). Said differently, existing prior art does not give players the ability to choose variables of a betting pool, i.e., they do not offer a variety of winning percentages to choose from which provides a steady stream of currency and holds a greater entertainment value. Further, increasing payout prizes is a poor method of increasing interest in instant-win lottery tickets because most lottery jurisdictions regulate payout percentage by charter and therefore cannot utilize higher payout tickets as a means of increasing sales.

Expanding distribution of Instant-Win tickets to new locations like vending machines, checkout lanes, and mobile apps has also been used to increase instant win ticket sales. However, the logistics, accountability, and security issues associated with placing instant-win lottery tickets are problematic and often impractical. Specifically, this is often an inefficient process that is vulnerable to accountability errors because all the components of game play are not centralized in a single location, e.g., a website. Recently electronic game cards have been introduced by the lottery industry. Although this method was understood to significantly increase entertainment value to the concept of an instant win lottery game, the game card was relatively expensive to manufacture. Moreover, current mobile applications are limited in advertising capabilities as they do not allow the player to select the advertising they want to receive and share. This is relevant as current advertising networks are becoming more dependent on social sharing. Existing prior art is further limited in entertainment value insofar as it does not allow users the ability to record, livestream, and/or share videos (e.g., a victory dance) in real time (e.g., when the user wins).

Therefore, a need exists to overcome the problems with the prior art as discussed above.

### SUMMARY OF THE INVENTION

The invention provides a computer-operated percentage-based lottery system and method that overcomes the hereinbefore-mentioned disadvantages of the heretofore-known devices and methods of this general type and that gives a player the ability to choose in all variables of a betting pool (except for a random pick of winners), adding significant entertainment value to the concept of an Instant-Win Lottery Game System. Beneficially, the present invention can maintain a steady stream of currency to the public as well as income for taxes to governing bodies. Because the present invention is Internet-based, it provides a continuous avenue to play, with players having access to play at all times. The present invention also provides a large-enough selection of betting pools to keep payout percentages at safe economic levels and centralizes all components of game play onto a single website or application, thereby simplifying the transaction process and minimizing the avenues for accountability errors. Players can pick the percentage they have of winning, choose an option of prizes, create a character, share a victory dance, interact in advertising networks, all while choosing the size of the betting pool they want to place a wager in. Because the player's account can be linked to the player's personal bank account, many of the issues associated with payouts for the players are also minimized. This also creates an easy to manage point of sale for the administrator or other authority.

The computer-operated percentage-based lottery system and method creates a more “exciting” experience for players due to advantages offered by the world-wide web. Since a large variety of betting pools must be offered simultaneously, the computer-operated percentage-based lottery system must be played via the internet like various existing betting pools. Because the internet is necessary, other advantages can be added to the computer-operated percentage-based lottery system such as communication with fellow players, the option to purchase variables and/or cancel purchased variables within betting pools on cyber tickets. A game account can be set up to allow electronic transactions between a player's personal bank account, allowing a player easier access to collect prizes. Players can also create a game character, set the range of advertisements they wish to share, as well as record and/or display a victory dance. Some of these advantages are not available with current lottery systems although online gambling is now offered via the internet in many states. In traditional lottery systems winning percentages only change with the number of tickets purchased. A player changes the percentages they have of winning by picking a multiplier in percentage builder games, raising or lowering the betting pool sizes in the High Risk High Reward percentage games, or choosing betting pools offering a set prize and winning percentage per Set Pot Percentage game cyber ticket. With traditional lottery systems, the player wagers against the host of the game. With the present invention, however, only players can win. In addition, the computer-operated percentage-based lottery system does not only benefit the players but also offers an easy to maintain economic stimulation for a thriving economy, as well, easing government pressure to maintain a healthy economic growth. Because of the internet, the present invention can do more than provide an array of gambling options. Governments and other authority systems can implement the present invention as a means of steady currency exchange.

With the foregoing and other objects in view, there is provided, in accordance with the invention, a computer-implemented process of conducting a percentage-based lottery comprising the steps of providing a plurality of user electronic computing devices each of a plurality of users, respectively; providing at least one server communicatively coupled to the plurality of user electronic computing devices over a network, with at least one computer processor, and with at least one non-transitory memory storing a plurality of user accounts thereon and each associated with one of the plurality of users, the at least one server operably configured to generate a plurality of user lottery pools each with varying defined limits of participants and with varying winning percentages associated therewith; communicatively coupling the plurality of user electronic computing devices with the at least one server; inputting, by the plurality of users, user-identifying information, a user-desired wagering amount into the electronic user interface of each of the plurality of user electronic computing devices, respectively, a user-desired winning percentage, of one of the plurality of varying winning percentages, into the electronic user interface of each of the plurality of user electronic computing devices, respectively; and a user-desired number of participants, of one of the varying defined limits of participants, into the electronic user interface of each of the plurality of user electronic computing devices, respectively; generating at least one user lottery pool from the plurality of user lottery pools onto the electronic user interface of each of the plurality of user electronic computing devices, respectively, dictated by the user-desired wagering amount, the user-desired winning percentage, and the user-desired number of participants; selecting the at least one user lottery pool from the plurality of user lottery pools by the plurality of users until reaching the user-desired number of participants associated with the at least one user lottery pool, wherein the reaching the user-desired number of participants associated with the at least one user lottery pool defines a triggering event; and after reaching the triggering event, randomly selecting, by the at least one server, a number of lottery winners based on the user-desired winning percentage and awarding the number of lottery winners based on the user-desired wagering amount and the user-desired winning percentage.

In accordance with another feature, an embodiment of the present invention includes executing a software application on each of the plurality of user electronic computing devices and then, in a graphical user interface on the electronic user interface generated by the software application, inputting the user-desired wagering amount, the user-desired winning percentage, and the user-desired number of participants.

In accordance with a further feature of the present invention, the process further comprises inputting the user-desired wagering amount, the user-desired winning percentage, and the user-desired number of participants through a digital scrolling feature depicting, on the graphical user interface, the plurality of user lottery pools each with the varying defined limits of participants, the varying winning percentages associated therewith, and a plurality of desired wagering amounts associated therewith.

In accordance with a further feature of the present invention, the process also includes selecting a plurality of user lottery pools from the plurality of user lottery pools by the plurality of users on the electronic user interface simultaneously.

In accordance with another feature, an embodiment of the present invention also includes contributing a digital current currency associated with and correlated to the user-desired wagering amount and the user-desired winning percentage to the at least one user account associated with the number of lottery winners.

In accordance with a further feature, the process includes generating, in a graphical user interface on the electronic user interface, a capacity meter displaying the real time participants associated with the at least one user lottery pool.

In accordance with yet another feature, the process further comprises executing a software application on each of the plurality of user electronic computing devices and enabling communication between the plurality of user electronic computing devices selecting the at least one user lottery pool, through the software application, only up until reaching the triggering event.

In accordance with the present invention, a percentage-based lottery software application operably configured to be downloaded on a plurality of user electronic computing devices each of a plurality of users, respectively, and comprising computer-readable instructions programed to initiate a lottery gaming session on each of the respective plurality of user electronic computing devices; receive, from each of the plurality of users in the lottery gaming session, user-identifying information, a user-desired wagering amount, a user-desired winning percentage, of one of a plurality of varying winning percentages, and a user-desired number of participants, of one of a varying defined limits of participants; generate a graphical user interface in the lottery gaming session having a digital scrolling feature depicting the plurality of user lottery pools each with the varying defined limits of participants, the varying winning percentages associated therewith, and a plurality of desired wagering amounts associated therewith; receive at least one user lottery pool from the plurality of user lottery pools onto an electronic user interface of each of the plurality of user electronic computing devices, respectively, dictated by the user-desired wagering amount, the user-desired winning percentage, and the user-desired number of participants; receive, from each of the plurality of users, a selection of at least one user lottery pool from the plurality of user lottery pools until reaching the user-desired number of participants associated with the at least one user lottery pool, wherein the reaching the user-desired number of participants associated with the at least one user lottery pool defines a triggering event; and randomly select, after reaching the triggering event, a number of lottery winners based on the user-desired winning percentage and award the number of lottery winners based on the user-desired wagering amount and the user-desired winning percentage.

In accordance with another feature, the percentage-based lottery software application includes computer-readable instructions programmed to contribute a digital current currency associated with and correlated to the user-desired wagering amount and the user-desired winning percentage to at least one user account associated with the number of lottery winners.

In accordance with another feature, an embodiment of the present invention also includes computer-readable instructions programmed to generate, in the graphical user interface on the electronic user interface, a capacity meter displaying the real time participants associated with the at least one user lottery pool.

In accordance with yet another feature, an embodiment of the present invention includes computer-readable instructions programmed to enable communication in the lottery gaming session between the plurality of user electronic computing devices selecting the at least one user lottery pool, through the software application, only up until reaching the triggering event.

In accordance with the present invention, at least one user electronic computing device with an executable percentage-based lottery software application resident thereon and operably configured to execute computer-readable instructions programed to initiate a lottery gaming session on each of the respective plurality of user electronic computing devices; receive, from each of the plurality of users in the lottery gaming session, user-identifying information, a user-desired wagering amount, a user-desired winning percentage, of one of a plurality of varying winning percentages, and a user-desired number of participants, of one of a varying defined limits of participants; generate a graphical user interface in the lottery gaming session having a digital scrolling feature depicting the plurality of user lottery pools each with the varying defined limits of participants, the varying winning percentages associated therewith, and a plurality of desired wagering amounts associated therewith; receive at least one user lottery pool from the plurality of user lottery pools onto an electronic user interface of each of the plurality of user electronic computing devices, respectively, dictated by the user-desired wagering amount, the user-desired winning percentage, and the user-desired number of participants; receive, from each of the plurality of users, a selection of at least one user lottery pool from the plurality of user lottery pools until reaching the user-desired number of participants associated with the at least one user lottery pool, wherein the reaching the user-desired number of participants associated with the at least one user lottery pool defines a triggering event; and randomly select, after reaching the triggering event, a number of lottery winners based on the user-desired winning percentage and award the number of lottery winners based on the user-desired wagering amount and the user-desired winning percentage.

In accordance with another feature, the electronic computing device is further operably configured to execute computer-readable instructions programed to contribute a digital current currency associated with and correlated to the user-desired wagering amount and the user-desired winning percentage to the at least one user account associated with the number of lottery winners.

In accordance with yet another feature, the electronic computing device is also operably configured to execute computer-readable instructions programmed to generate, in the graphical user interface on the electronic user interface, a capacity meter displaying the real time participants associated with the at least one user lottery pool.

In accordance with a further feature of the present invention, the electronic computing device is operably configured to execute computer-readable instructions programed to enable communication in the lottery gaming session between the plurality of user electronic computing devices selecting the at least one user lottery pool, through the software application, only up until reaching the triggering event.

Although the invention is illustrated and described herein as embodied in a computer-operated percentage-based lottery system and method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skills in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary, or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an exemplary network implementing a percentage-based lottery software application in accordance with one embodiment of the present invention;

FIG. 2 is a block diagram depicting exemplary electrical components utilized in one or more of the user electronic computing devices in accordance with embodiments of the present invention;

FIGS. 3a-b depict a process flow diagram depicting a computer-implemented process of conducting a percentage-based lottery in accordance with one embodiment of the present invention;

FIGS. 4-11 depict charts depicting a plurality of user lottery pools, in accordance with embodiments of the present invention; and

FIGS. 12-38 depict exemplary screenshots of a graphical user interface of the percentage-based lottery software application, in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient Internet-based gaming method carried out by multiple users over a network and, more particularly, a computer-operated, percentage-based lottery system and method operated by multiple users utilizing an electronic computing device. Embodiments of the invention provide a percentage-based lottery software application that allows players to purchase desired variables in betting pools that choose winners according to the percentage chosen by the players in the betting pool. The percentage-based lottery system and method includes one centralized website/mobile application that can be linked to a player's personal bank account or to transfer currency to and from their game accounts on the website/mobile application. In addition to selecting their choice of variables in a variety of betting pools, a player can create a character to display, communicate with fellow players, record and/or share a victory dance, and share desired advertisements with other players within the chosen betting pools.

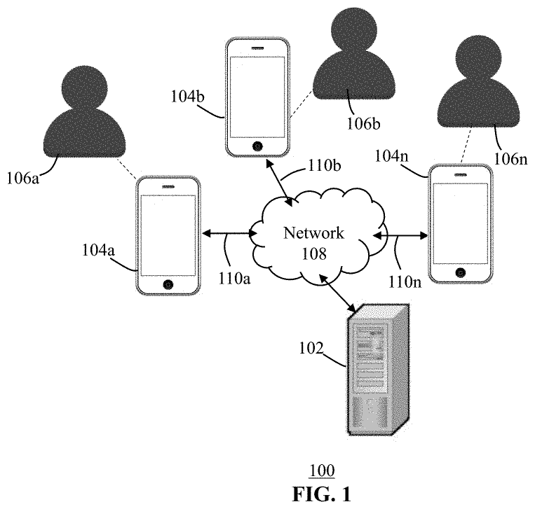

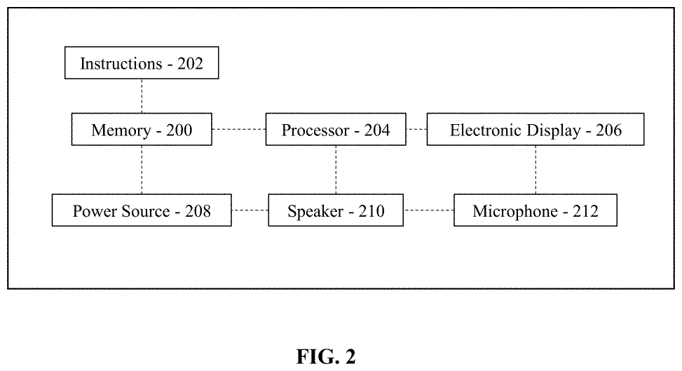

Referring now to FIG. 1, one embodiment of the present invention implemented over a network 108 is shown in a schematic view. FIG. 1 along with the other figures depicted herein show several advantageous features of the present invention, but, as will be described below, the invention can be provided in several shapes, sizes, combinations of features and components, and varying numbers and functions of the components. The first example of a percentage-based lottery software application implemented over a network 108 is shown in FIG. 1. The invention requires at least two user electronic computing devices 104a-n, wherein “n” represents any number greater than one and, as described further below, enables a player to play a percentage-based lottery.

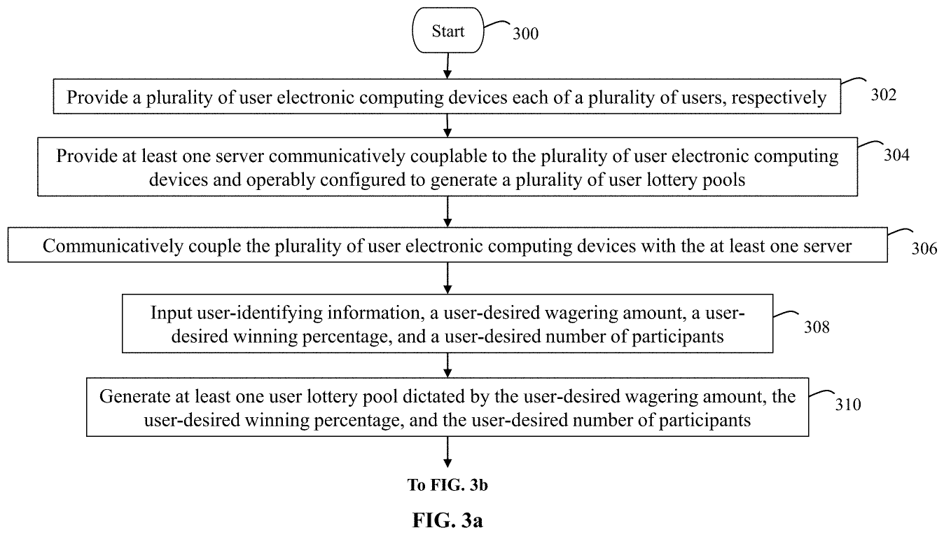

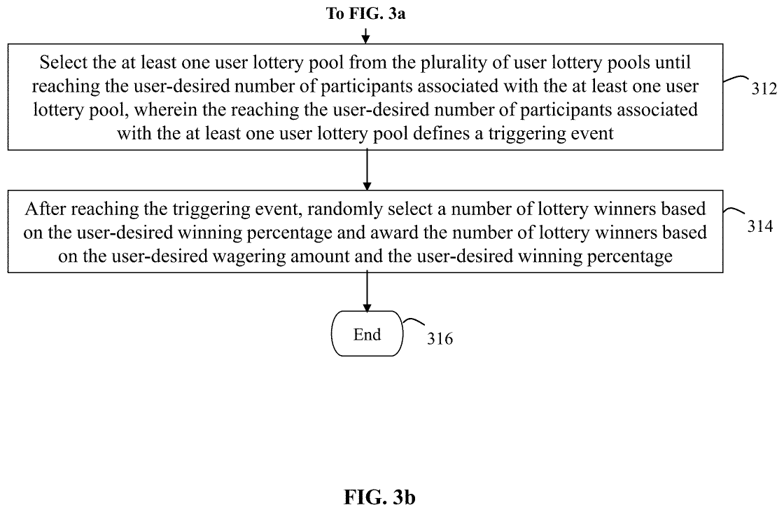

As seen in the figures, the software application is beneficially downloadable and downloaded onto the plurality of electronic computing devices 104a-n. The downloading may occur at separate times and may originate from an administrative server 102 that may also be operable to communicatively couple the devices 104a-n over the network 108. Although the electronic computing devices 104a-n are depicted as mobile phones, they may be other computing devices, such as tablets. In one embodiment, the software application is operably configured to be downloadable and/or downloaded on a first user electronic computing device 104a, e.g., a first player, and a second user electronic computing device 104b, e.g., a second player. With reference to FIG. 2, the software application includes computer-readable instructions and/or a medium 202 (e.g., written with objective-C, Swift, Laravel, Python, C++, etc.) programmed to carry out steps implementing the present invention. As appreciated by those of skill in the art, the instructions may be stored on the devices 104a-n and, when executed by a computer, cause the device to perform the inventive method described herein and exemplified in FIGS. 3a-b.

With reference to FIG. 1, the software application, devices 104a-n, system, and method may be operated over the network 108 and includes connections 110a-n, which are the medium used to provide communications links between various devices and computing devices connected together. The connections 110a-n may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

The network 108 may also include the Internet, which represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network 108 also may be implemented as a number of different types of networks, such as for example, an Intranet, a local area network (LAN), a wide area network (WAN), a cellular network. FIG. 1 is intended as an example, and not as an architectural limitation for the present invention. The network 108 may also include additional servers and other devices and entities not shown.

FIG. 2 depicts a schematic block diagram of electrical components that may be coupled to or otherwise included on the devices 104a-n and one or more servers 102. Some of these components includes a non-transitory memory 200 having the instructions 202 stored thereon, a processor 204 for implementing the instructions, an electronic display 206, a power source 208 (e.g., battery) providing power to the electrical components utilized in the device, and a speaker 210, microphone 212, or other transducers. Other components, however, may be utilized.

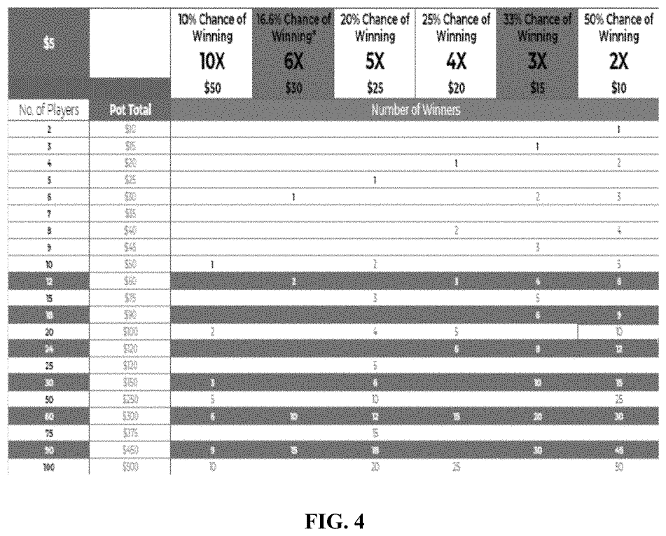

FIGS. 4-11 will now be described in conjunction with the process flow chart of FIGS. 3a-b. Although FIGS. 3a-b shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIGS. 3a-b for the sake of brevity. In some embodiments, some or all of the process steps are included in FIGS. 3a-b can be combined into a single process. Specifically, a computer-implemented process of conducting a percentage-based lottery begins at step 300 and immediately proceeds to step 302, which includes providing the plurality of user electronic computing devices 104a-n, each of the plurality of users 106a-n, respectively. Next, step 304 comprises providing the at least one server 102 communicatively coupled to the plurality of user electronic computing devices 104a-n over the network 108, with the at least one computer processor 204, and with the at least one non-transitory memory 200 storing a plurality of user accounts thereon and each associated with one of the plurality of users 106a-n, the at least one server 102 operably configured to generate a plurality of user lottery pools (also referred to as a “betting pool” herein) each with varying defined limits of participants and with varying winning percentages associated therewith. The plurality of user lottery pools may be generated by the server 102, itself, and/or may be facilitated by the plurality of user electronic computing devices 104a-n.

The varying winning percentages associated with any given user lottery pool, and the number of winners offered in any given user lottery pool, is presented according to percentages offered: 10% betting pools offer a selection of; 1 winner per 10 players/2 winners per 20 players/3 winners per 30 players/5 winners per 50 players/6 winners per 60 players/9 winners per 90 players/10 winners per 100 players. 16.6% betting pools are presented with a selection of 1 winner per 6 players/2 winners per 12 players/10 winners per 60 players/15 winners per 90 players. 20% betting pools are presented with a selection of 1 winner per 5 players/2 winners per 10 players/3 winners per 15 players/4 winners per 20 players/5 winners per 25 players/6 winners per 30 players/10 winners per 50 players/12 winner per 60 players/15 winners per 75 players/18 winners per 90 players/20 winners per 100 players, 25% betting pools are presented with a selection of 1 winner per 4 players/2 winners per 8 players/3 winners per 12 players/5 winners per 20 players/6 winners per 24 players/15 winners per 60 players/25 winners per 100 players, 33% betting pools are presented with a selection of 1 winner per 3 players/2 winners per 6 players/3 winners per 9 players/4 winners per 12 players/5 winners per 15 players/6 winners per 18 players/8 winners per 24 players/10 winners per 30 players/20 winners per 60 players/30 winner per 90 players, 50% betting pools are presented with a selection of 1 winner per 2 players/2 winners per 4 players/3 winners per 6 players/4 winners per 8 players/5 winners per 10 players/6 winners per 12 players/9 winners per 18 players/10 winners per 20 players/12 winners per 24 players/15 winners per 30 players/25 winners per 50 players/30 winners per 60 players/45 winners per 90 players/50 winners per 100 players.

Next, the process includes step 306 of communicating the plurality of user electronic computing devices 104a-n with at least one server 102. As explained in greater detail above, the plurality of user electronic computing devices 104a-n are communicatively coupled with the server 102 over the network 108 (e.g., the Internet) in an exemplary embodiment.

Step 308 includes inputting, by the plurality of users 106a-n, user-identifying information (e.g., name, phone number, account name, password, etc.); a user-desired wagering amount into the electronic user interface of each of the plurality of user electronic computing devices 104a-n, respectively; a user-desired winning percentage, of one of the plurality of varying winning percentages, into the electronic user interface of each of the plurality of user electronic computing devices 104a-n, respectively; and a user-desired number of participants, of one of the varying defined limits of participants, into the electronic user interface of each of the plurality of user electronic computing devices 104a-n, respectively. This data may be input manually through the user interface of the device 104a, through an auxiliary input, or dictated into a field by using a microphone.

Next, step 310 comprises generating at least one user lottery pool from the plurality of user lottery pools onto the electronic user interface of each of the plurality of user electronic computing devices 104a-n, respectively, dictated by the user-desired wagering amount, the user-desired winning percentage, and the user-desired number of participants. Thereafter, step 312 includes selecting the at least one user lottery pool from the plurality of user lottery pools by the plurality of users 106a-n until reaching the user-desired number of participants associated with the at least one user lottery pool, wherein the reaching the user-desired number of participants associated with the at least one user lottery pool defines a triggering event. Said differently, once the user-desired number of participants associated with the at least one user lottery pool has been reached, the at least one user lottery pool is automatically closed and other users are prevented from entering the pool. A capacity meter may display the real time participants associated with at least one user lottery pool to accurately and timely inform prospective participants of the current (and total) capacity of the user lottery pool, e.g., whether it is open or closed, how many spots remain, etc. The capacity meter is displayed or reflected in the graphical user interface on the electronic user interface of the plurality of user electronic computing devices 104a-n. After reaching the triggering event, a next step 314 includes randomly selecting, by the at least one server 102, a number of lottery winners based on the user-desired winning percentage and awarding the number of lottery winners based on the user-desired wagering amount and the user-desired winning percentage. By being able to choose the desired wagering amount, winning percentage, and number of participants, players are better able to customize and control the financial risk they decide to take on. The foregoing choices also serve to add a greater entertainment value to the percentage-based lottery software application.

In an exemplary embodiment, the computer-implemented process also includes executing a software application on each of the plurality of user electronic computing devices 104a-n and then, in a graphical user interface on the electronic user interface generated by the software application, inputting the user-desired wagering amount, the user-desired winning percentage, and the user-desired number of participants. Said differently, the computer-implemented process is embodied in a software application that is downloadable by a user. In another embodiment, the executable percentage-based lottery software application is resident on at least one user electronic computing device 104a-n. The graphical user interface may comprise a digital scrolling feature depicting the plurality of user lottery pools each with the varying defined limits of participants, the varying winning percentages associated therewith, and a plurality of desired wagering amounts associated therewith. Users may thereafter input the user-desired wagering amount, the user-desired winning percentage, and the user-desired number of participants through a digital scrolling feature on the graphical user interface.

In accordance with a further feature, the computer implemented process may also include selecting a plurality of user lottery pools from the plurality of user lottery pools by the plurality of users 106a-n on the electronic user interface simultaneously. This feature beneficially enables players to enter or join more than one user lottery pool at one time, i.e., if they desire to benefit from a variety of winning percentages, wagering amounts, etc. To distribute funds to the lottery winner(s), the process may include contributing a digital currency associated with and correlated to the user-desired wagering amount and the user-desired winning percentage to at least one user account associated with the number of lottery winners. The digital currency may entail, by way of example and without limitation, a digital credit or token that the lottery winner can apply to its user account (e.g., to make another wager) or withdraw (e.g., by transferring to its bank account).

In one embodiment, the software application may enable communication between the plurality of user electronic computing devices selecting the at least one user lottery pool, only up until reaching the triggering event. Said differently, participants of each user lottery pool may be able to communicate with one another until the triggering event is reached, i.e., the user lottery pool is closed and lottery winners are thereafter selected.

A percentage-based lottery software application is disclosed that is operably configured to be downloaded on a plurality of user electronic computing devices 104a-n each of a plurality of users 106a-n, respectively, and that comprises computer-readable instructions programed to initiate a lottery gaming session on each of the respective plurality of user electronic computing devices 104a-n; receive, from each of the plurality of users 106a-n in the lottery gaming session, user-identifying information, a user-desired wagering amount, a user-desired winning percentage, and a user-desired number of participants; generate a graphical user interface in the lottery gaming session having a digital scrolling feature depicting the plurality of user lottery pools each with the varying defined limits of participants, the varying winning percentages associated therewith, and a plurality of desired wagering amounts associated therewith; receive at least one user lottery pool from the plurality of user lottery pools onto an electronic user interface of each of the plurality of user electronic computing devices 104a-n, respectively, dictated by the user-desired wagering amount, the user-desired winning percentage, and the user-desired number of participants; receive, from each of the plurality of users 106a-n, a selection of at least one user lottery pool from the plurality of user lottery pools until reaching the user-desired number of participants associated with the at least one user lottery pool, wherein the reaching the user-desired number of participants associated with the at least one user lottery pool defines a triggering event; and randomly select, after reaching the triggering event, a number of lottery winners based on the user-desired winning percentage and award the number of lottery winners based on the user-desired wagering amount and the user-desired winning percentage. The computer-readable instructions may also be programed to contribute a digital currency to the at least one user account associated with the number of lottery winners, to generate a capacity meter, and/or to enable communication in the lottery gaming session between the plurality of user electronic computing devices selecting the at least one user lottery pool.

The percentage-based lottery system and method has a payout cap of $10,000,000 with only 10 available winners in a betting pool. Like most online gambling systems that have currency prizes, players are given a variety of amounts to wager. This Percentage-Based Instant Win Lottery System offers wager amounts that range from $1 to $1,000,000. Prizes offered in a range from $2 to $10,000,000 per Cyber Ticket. Players can also choose the percentage they have of winning that range from 0.000001% to 50% per Cyber Ticket, in betting pools that range from 2 players to 100,000,000 players. In total this Percentage-Based Instant Win Lottery System offers at least 919 betting pools to choose from. This wide range of options gives the player a variety of set variables to choose from within betting pools. With the Percentage-Based Instant Win Lottery System players will have the option to pick from various betting pools presented simultaneously. Making the Percentage-Based Lottery System manageable via the internet. Because of this, other advantages are added to this online lottery system, such as private communication between players on a Direct Message Webpage, and/or public communication in the Game Comments Fields on a Cyber Gameboard's Comments Webpage. Players are allowed the option to record a victory dance on the Dance Recorder Webpage and display their victory dance in a Results Window of a purchased Cyber Ticket. Players have options on advertisements received by entering a #1 Dream Entry on the Cyber Gameboard's Dream Webpage and able to share advertisements in the Results Windows of purchased Cyber Tickets.

Several exemplary embodiments of the user lottery pools (also referred to herein as “cyber game boards”), the user-desired wagering amounts, the user-desired winning percentages, and the user-desired number of participants are described in greater detail below.

Percentage Builder Games offers wager amounts of; $5/$10/$15/$20/$25/$50/$100/$500/$1,000/$5,000/$10,000/$25,000/$50,000/$100,000/$250,000/$500,000/$1,000,000. Percentage Builder Cyber Gameboards (betting pools) present winning percentage amounts (Multipliers) of; 10%, 16.6%, 20%, 25%, 33%, 50%. The Percentage Builder Cyber Gameboards sell Cyber Tickets in betting pools that range from 2-100 players. The number of winners offered in a betting pool is presented according to percentages offered: 10% betting pools offer a selection of; 1 winner per 10 players/2 winners per 20 players/3 winners per 30 players/5 winners per 50 players/6 winners per 60 players/9 winners per 90 players/10 winners per 100 players. 16.6% betting pools are presented with a selection of 1 winner per 6 players/2 winners per 12 players/10 winners per 60 players/15 winners per 90 players. 20% betting pools are presented with a selection of 1 winner per 5 players/2 winners per 10 players/3 winners per 15 players/4 winners per 20 players/5 winners per 25 players/6 winners per 30 players/10 winners per 50 players/12 winner per 60 players/15 winners per 75 players/18 winners per 90 players/20 winners per 100 players, 25% betting pools are presented with a selection of 1 winner per 4 players/2 winners per 8 players/3 winners per 12 players/5 winners per 20 players/6 winners per 24 players/15 winners per 60 players/25 winners per 100 players, 33% betting pools are presented with a selection of 1 winner per 3 players/2 winners per 6 players/3 winners per 9 players/4 winners per 12 players/5 winners per 15 players/6 winners per 18 players/8 winners per 24 players/10 winners per 30 players/20 winners per 60 players/30 winner per 90 players, 50% betting pools are presented with a selection of 1 winner per 2 players/2 winners per 4 players/3 winners per 6 players/4 winners per 8 players/5 winners per 10 players/6 winners per 12 players/9 winners per 18 players/10 winners per 20 players/12 winners per 24 players/15 winners per 30 players/25 winners per 50 players/30 winners per 60 players/45 winners per 90 players/50 winners per 100 players. Formulas; (wager amount*the number of players=amount of currency in the betting pool). (The number of players*the winning percentage=Number of winners in a betting pool). (The amount of currency in a pool/by the number of winners in a pool=the prize awarded to winners in the betting pools).

High Risk High Reward percentage games offer a set wager amount of $2 per Cyber Ticket. These betting pools (Cyber Gameboards) contain player amounts of; 4/6/8/10/12/14/16/18/20/40/50/1,000 and only allow two winners in a Money Drop per Cyber Gameboard. The Winning Percentages offered vary per Cyber Ticket with each pool offered. A betting pool size of 4 players: offer a 50% winning percentage per Cyber Ticket. A betting pool size of 6 players: offer a 33% winning percentage per Cyber Ticket. A betting pool size of 8 players: offer a 25% winning percentage per Cyber Ticket. A betting pool size of 10 players: offer a 20% winning percentage per Cyber Ticket. A betting pool size of 12 players: offer a 16.6% winning percentage per Cyber Ticket. A betting pool size of 14 players: offer a 14.2% winning percentage per Cyber Ticket. A betting pool size of 16 players: offer a 12.5% winning percentage per Cyber Ticket. A betting pool size of 18 players: offer a 11.1% winning percentage per Cyber Ticket. A betting pool size of 20 players: offer a 10% winning percentage per Cyber Ticket. A betting pool size of 40 players: offer a 5% winning percentage per Cyber Ticket. A betting pool size of 50 players: offer a 4% winning percentage per Cyber Ticket. A betting pool size of 1,000 players: offer a 0.2% winning percentage per Cyber Ticket. These winning percentages are offered per Cyber Ticket in the High Risk High Reward percentage game's Cyber Game Boards. Formulas; (size of the pool*$2/by 2=the prize to each winner in the betting pool.

Set Pot Percentage games are betting pools (Cyber Game Boards) that offer various currency prizes at a set wage of $1 per Cyber Ticket. The $1 per Cyber Ticket Cyber Gameboard/betting pool with a $100 prize offers a 100,000-player pool size: picking 1,000 random winners in the Money Drop (1% winning percentage per Cyber Ticket). The $1 per Cyber Ticket Cyber Gameboard/betting pool with a $1,000 prize offers a 100,000-player pool size: picking 100 random winners in the Money Drop (0.1% winning percentage per Cyber Ticket). The $1 per Cyber Ticket Cyber Gameboard/betting pool with a $10,000 prize offers a 1,000,000-player pool size: picking 100 random winners in the Money Drop (0.01% winning percentage per Cyber Ticket). The $1 per Cyber Ticket Cyber Gameboard/betting pool with a $100,000 prize offers a 10,000,000-player pool size: picking 100 random winners in the Money Drop (0.001% winning percentage per Cyber Ticket). The $1 per Cyber Ticket Cyber Gameboard betting pool with a $1,000,000 prize offers a 10,000,000-player pool size: picking 10 random winners in the Money Drop (0.0001% winning percentage per Cyber Ticket). The $1 per Cyber Ticket Cyber Gameboard/betting pool with a $10,000,000 prize offers a 100,000,000-player pool size: picking 10 random winners in the Money Drop (0.000001% winning percentage per Cyber Ticket).

FIG. 4 depicts a percentage builder game chart that explains and displays the betting pools available. Percentage Builder Games offers wager amounts of; $5/$10/$15/$20/$25/$50/$100/$500/$1,000/$5,000/$10,000/$25,000/$50,000/$100,000/$250,000/$500,000/$1,000,000. Percentage Builder Cyber Gameboards (betting pools) present winning percentage amounts (Multipliers) of; 10%, 16.6%, 20%, 25%, 33%, 50%. The Percentage Builder Cyber Gameboards sell Cyber Tickets in betting pools that range from 2-100 players. Formulas; (wager amount*the number of players=amount of currency in the betting pool). (The number of players*the winning percentage=Number of winners in a betting pool). (The amount of currency in a pool/by the number of winners in a pool=the prize awarded to winners in the betting pools). The “Bet Amount” directly affects the Pot total Column and the prize displayed at the top of each Multiplier Column. The “Number of Players Column” will display the number of Cyber Tickets available. “Pot Total Column” displays the winning Pots available according to the number of players. The “10× Multiplier Column” displays the prize and winning percentage at the top of the column: =(# of Players*0.1). 10% betting pools offer a selection of: 1 winner of 10 players/2 winners of 20 players/3 winners of 30 players/5 winners of 50 players/6 winners of 60 players/9 winners of 90 players/10 winners of 100 players. The “6× Multiplier Column” column displays the prize and winning percentage at the top of the column: =(# of Players*0.1666666667). 16.6% betting pools are presented with a selection of: 1 winner of 6 players/2 winners of 12 players/10 winners of 60 players/15 winners of 90 players. The “5× Multiplier Column” displays the prize and winning percentage at the top of the column: =(# of Players*0.20). 20% betting pools are presented with a selection of 1 winner of 5 players/2 winners of 10 players/3 winners of 15 players/4 winners of 20 players/5 winners of 25 players/6 winners of 30 players/10 winners of 50 players/12 winner of 60 players/15 winners of 75 players/18 winners of 90 players/20 winners of 100 players. The “4× Multiplier Column” displays the prize and winning percentage at the top of the column: =(# of Players*0.25). 25% betting pools are presented with a selection of 1 winner of: 4 players/2 winners of 8 players/3 winners of 12 players/5 winners of 20 players/6 winners of 24 players/15 winners of 60 players/25 winners of 100 players. The “3× Multiplier Column” displays the prize and winning percentage at the top of the column: =(# of Players*0.33). 33% betting pools are presented with a selection of: 1 winner of 3 players/2 winners of 6 players/3 winners of 9 players/4 winners of 12 players/5 winners of 15 players/6 winners of 18 players/8 winners of 24 players/10 winners of 30 players/20 winners of 60 players/30 winner of 90 players. The “2× Multiplier Column” displays the prize and winning percentage at the top of the column: =(# of Players*0.50). 50% betting pools are presented with a selection of: 1 winner of 2 players/2 winners of 4 players/3 winners of 6 players/4 winners of 8 players/5 winners of 10 players/6 winners of 12 players/9 winners of 18 players/10 winner of 20 players/12 winners of 24 players/15 winners of 30 players/25 winners of 50 players/30 winners of 60 players/45 winners of 90 players/50 winners of 100 players. The “Number of winners” entries will display the betting pools available according to the number of players and the winning percentages available.

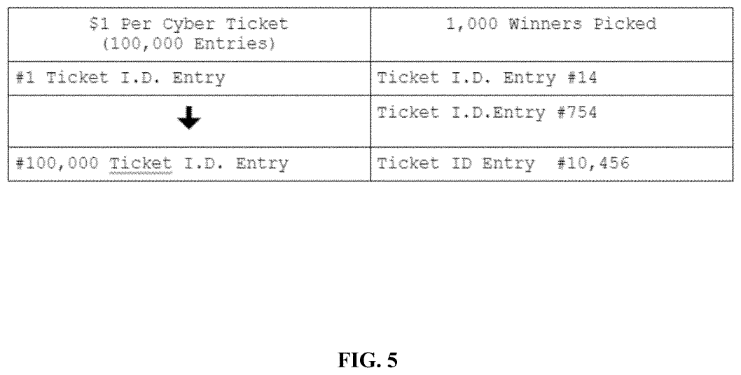

As depicted in FIG. 5, Set Pot Percentage games are betting pools (Cyber Game Boards) that offer various currency prizes for $1 per Cyber Ticket. The $1 per Cyber Ticket Cyber Gameboard/betting pool with a $100 prize offers a 100,000-pool size: picking 1,000 random winners in the Money Drop (1% winning percentage per Cyber Ticket). “Number of Tickets” column contains the number of Cyber Tickets to be purchased in the Cyber Gameboard/betting pool. The “Chart Title” displays the number of Cyber Tickets that need to be purchased to trigger the Money Drop and the price of a Cyber Ticket and the Title of the betting pool. The “Winners Window” will display the number of winners to be picked in Money Drop. The “Prize Box” displays the prize to be awarded to each winner.

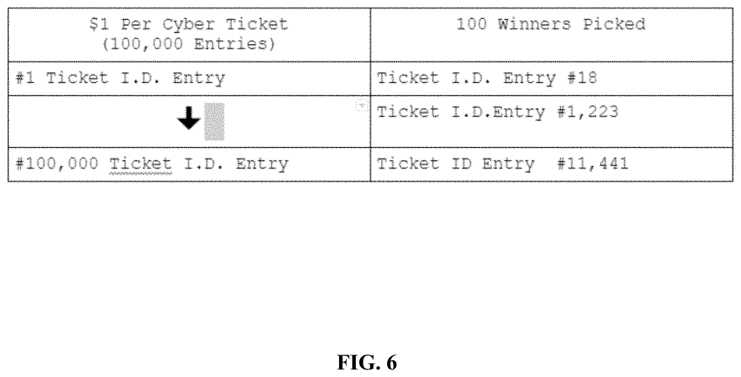

Referring now to FIG. 6, Set Pot Percentage games are betting pools (Cyber Game Boards) that offer various currency prizes for $1 per Cyber Ticket. The $1 per Cyber Ticket Cyber Gameboard/betting pool with a $1,000 prize offers a 100,000-pool size: picking 100 random winners in the Money Drop. (0.1% winning percentage per Cyber Ticket). “Number of Tickets” column contains the number of Cyber Tickets to be purchased in the Cyber Gameboard/betting pool. The “Chart Title” displays the number of Cyber Tickets that need to be purchased to trigger the Money Drop and the price of a Cyber Ticket and the Title of the betting pool. The “Winners Window” will display the number of winners to be picked in Money Drop. The “Prize Box” displays the prize to be awarded to each winner.

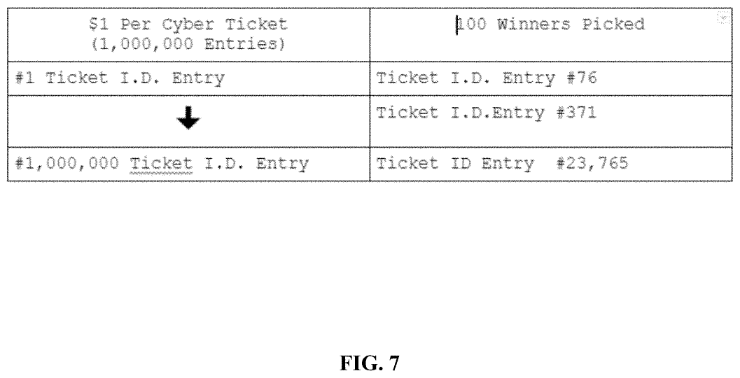

Referring now to FIG. 7, Set Pot Percentage games are betting pools (Cyber Game Boards) that offer various currency prizes for $1 per Cyber Ticket. The $1 per Cyber Ticket Cyber Gameboard/betting pool with a $10,000 prize offers a 1,000,000-pool size: picking 100 random winners in the Money Drop. (0.01% winning percentage per Cyber Ticket). “Number of Tickets” column contains the number of Cyber Tickets to be purchased in the Cyber Gameboard/betting pool. The “Chart Title” displays the number of Cyber Tickets that need to be purchased to trigger the Money Drop and the price of a Cyber Ticket and the Title of the betting pool. The “Winners Window” will display the number of winners to be picked in Money Drop. The “Prize Box” displays the prize to be awarded to each winner.

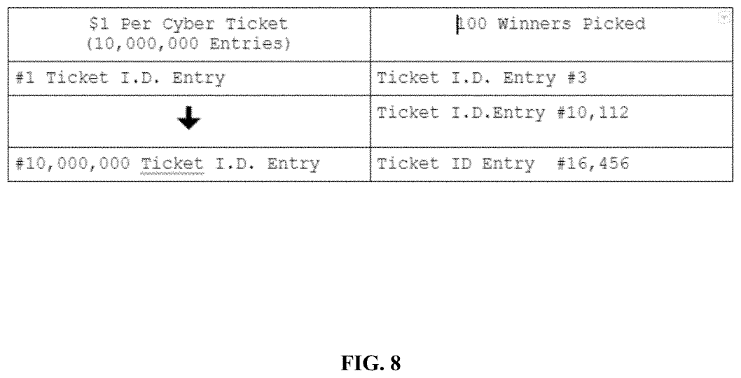

Referring now to FIG. 8, Set Pot Percentage games are betting pools (Cyber Game Boards) that offer various currency prizes for $1 per Cyber Ticket. The $1 per Cyber Ticket Cyber Gameboard/betting pool with a $100,000 prize offers a 10,000,000-pool size: picking 100 random winners in the Money Drop. (0.001% winning percentage per Cyber Ticket). “Number of Tickets” column contains the number of Cyber Tickets to be purchased in the Cyber Gameboard/betting pool. The “Chart Title” displays the number of Cyber Tickets that need to be purchased to trigger the Money Drop and the price of a Cyber Ticket and the Title of the betting pool. The “Winners Window” will display the number of winners to be picked in Money Drop. The “Prize Box” displays the prize to be awarded to each winner.

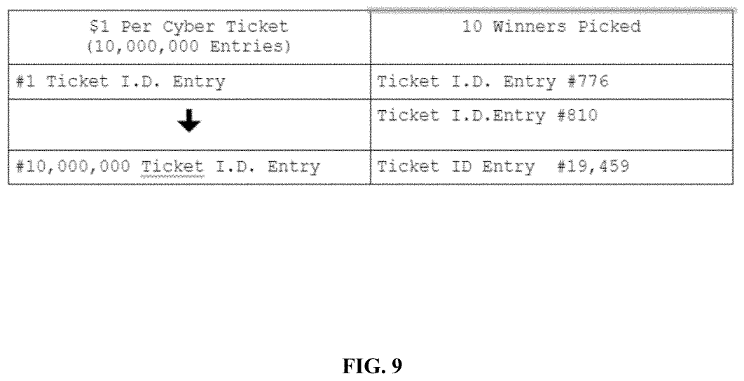

Referring now to FIG. 9, Set Pot Percentage games are betting pools (Cyber Game Boards) that offer various currency prizes for $1 per Cyber Ticket. The $1 per Cyber Ticket Cyber Gameboard betting pool with a $1,000,000 prize offers a 10,000,000-pool size: picking 10 random winners in the Money Drop. (0.0001% winning percentage per Cyber Ticket). “Number of Tickets” column contains the number of Cyber Tickets to be purchased in the Cyber Gameboard/betting pool. The “Chart Title” displays the number of Cyber Tickets that need to be purchased to trigger the Money Drop and the price of a Cyber Ticket and the Title of the betting pool. The “Winners Window” will display the number of winners to be picked in Money Drop. The “Prize Box” displays the prize to be awarded to each winner.

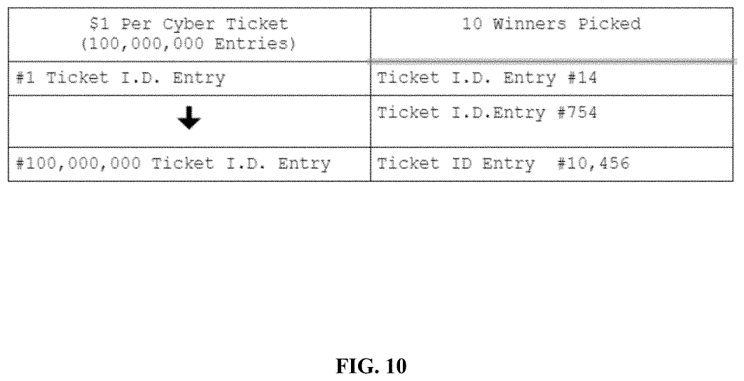

Referring now to FIG. 10, Set Pot Percentage games are betting pools (Cyber Game Boards) that offer various currency prizes for $1 per Cyber Ticket. The $1 per Cyber Ticket Cyber Gameboard/betting pool with a $10,000,000 prize offers a 100,000,000-pool size: picking 10 random winners in the Money Drop. (0.000001% winning percentage per Cyber Ticket). “Number of Tickets” column contains the number of Cyber Tickets to be purchased in the Cyber Gameboard/betting pool. The “Chart Title” displays the number of Cyber Tickets that need to be purchased to trigger the Money Drop and the price of a Cyber Ticket and the Title of the betting pool. The “Winners Window” will display the number of winners to be picked in Money Drop. The “Prize Box” displays the prize to be awarded to each winner.

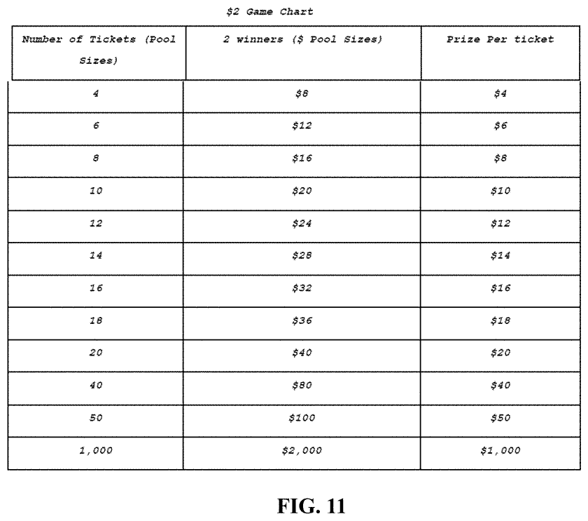

Referring now to FIG. 11, High Risk High Reward percentage game Chart. Will display the various betting pools provided by the High Risk High Reward percentage games. The games will be determined by the pools available in the “Number of Tickets Entries”. “Number of Tickets” column contains the number of Cyber Tickets to be purchased in the Cyber Gameboard/betting pool. The “Pot Column” will display 2 winners and the amount of currency to be won in each betting pool. The “Prize Column” displays the prizes to be awarded to each winner according to the size of the betting pool and Pot Column.

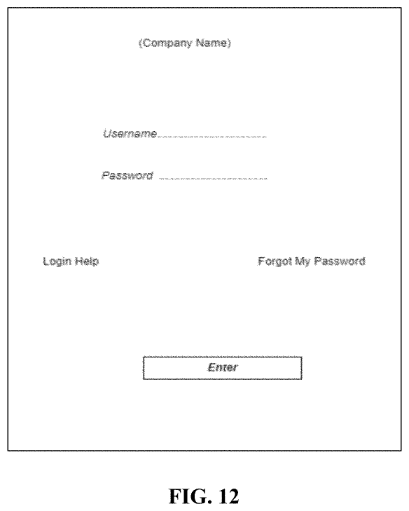

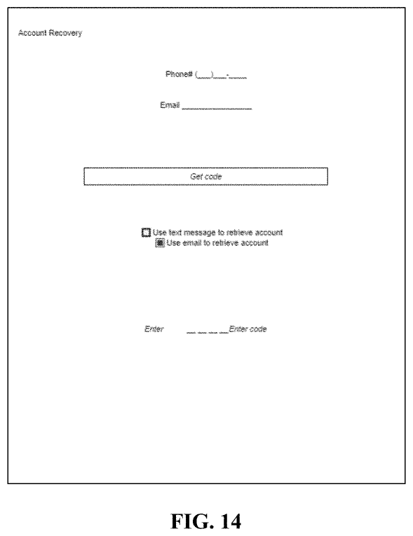

FIGS. 12-38 depict exemplary screenshots of the graphical user interface of the percentage-based lottery software application, in accordance with an exemplary embodiment of the present invention. FIG. 12 depicts the Login Webpage, that allows a player access to their game account by way of username and password. This webpage also offers login help and access to the Account Recovery Webpage, represented in FIG. 14.

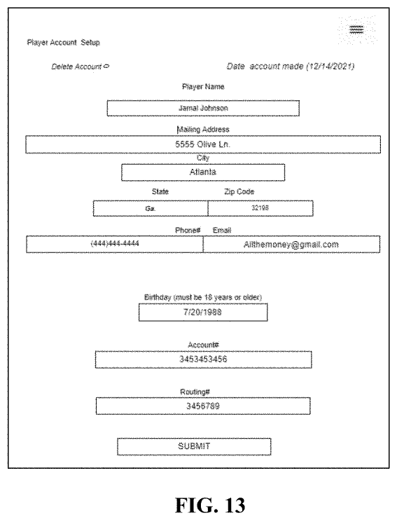

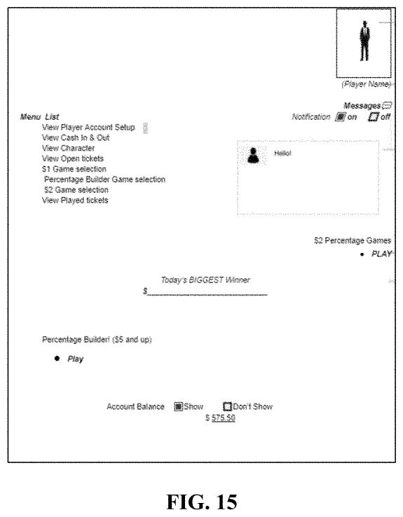

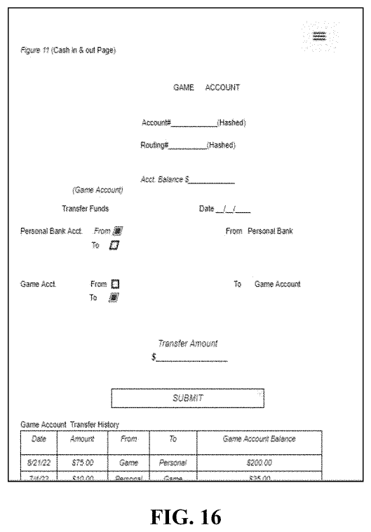

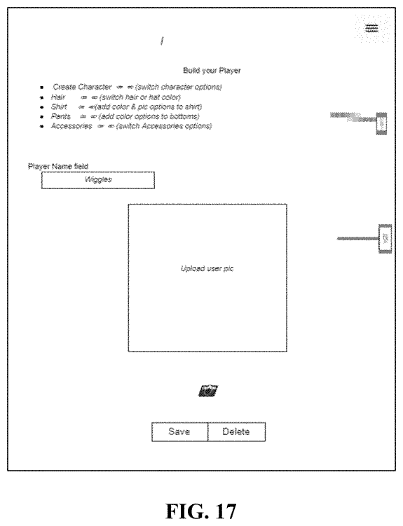

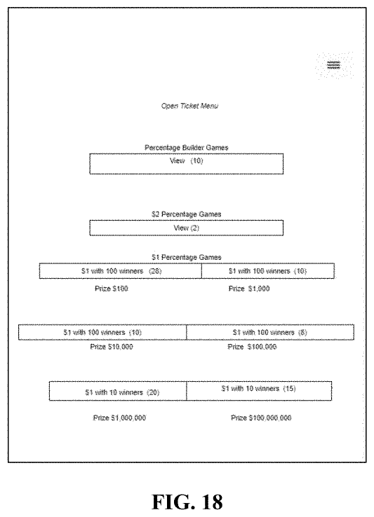

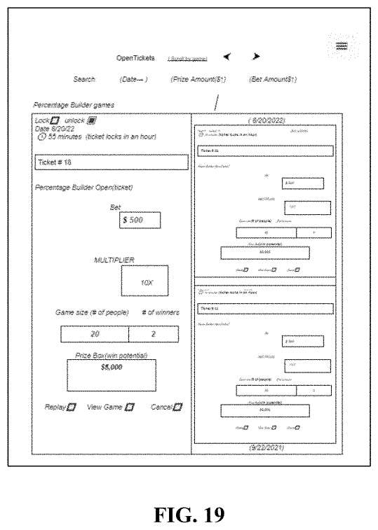

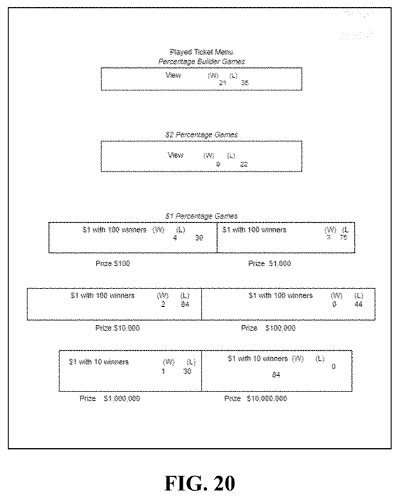

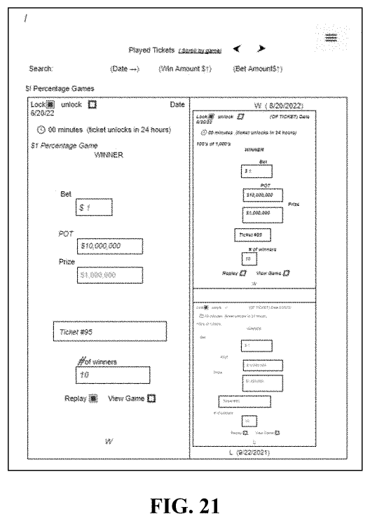

FIG. 13 represents the Player Account Setup Webpage. This webpage was designed for a player to enter their game account details to be linked to a URL address. FIG. 14 represents the Account Recovery Webpage. This webpage gives a player the ability to recover their accounts via text message or email. FIG. 15 represents the Main Menu Webpage, that will allow a player to navigate through the website to retrieve desired webpages. This webpage will display messages recently sent to the player as well as the largest prize for the current day. FIG. 16 represents the Cash In & Out Webpage. This webpage will allow a player to manage their game account. FIG. 17 represents the Build Your Player Webpage. This webpage gives a player the option to create a game character or download a picture to save as a player icon. FIG. 18 represents the Open Ticket Menu webpage, that will display options to help a player retrieve a purchased Cyber Ticket that has not participated in a Money Drops from the Open Ticket Search Webpage, represented in FIG. 19. Options are presented according to the games available. FIG. 19 represents the Open Ticket Search Webpage. This webpage allows a player to do a more detailed search to retrieve purchased Cyber Tickets that have not participated in a Money Drop. FIG. 20 represents the Played Ticket Menu Webpage. This webpage allows a player to choose a betting pool to retrieve a Cyber Ticket from the Played Ticket Search Webpage, represented in FIG. 21. This webpage allows a player to view the number of Cyber Tickets a player has purchased in games (Cyber Gameboards) that have had a Money Drop.

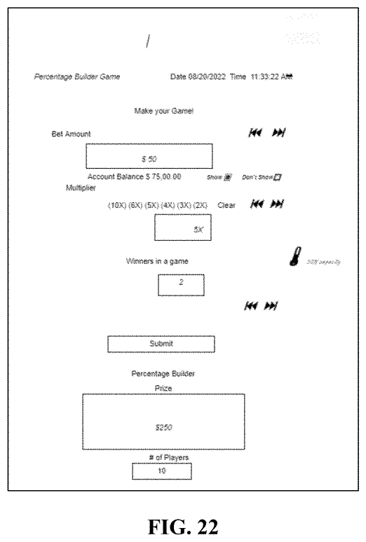

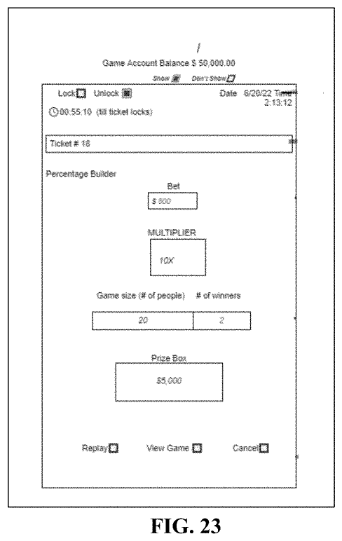

FIG. 21 represents the Played Ticket Search Webpage, that will let a player do a more detailed search to retrieve Cyber Tickets that have participated in a Money Drop. FIG. 22 represents the Percentage Builder Selection Webpage. This webpage grants a player the ability to choose the amount of currency they want to wager, the winning percentage they want to bet with (multiplier), as well as the amount of people they want to bet against before purchasing the Cyber Ticket in a Percentage Builder Cyber Gameboard (betting pool). The capacity of the betting pool selected will be displayed also. FIG. 23 represents the Percentage Builder Open Ticket Webpage. This webpage allows players to view the status and variables of a Percentage Builder Cyber Ticket purchased in a Percentage Builder Cyber Gameboard (game) that has not participated in a Money Drop. This webpage allows a player to view the Percentage Builder Cyber Gameboard of the Percentage Builder Cyber Ticket, repurchase a Percentage Builder Cyber Ticket with the same variables, and/or cancel the Percentage Builder Cyber Ticket.

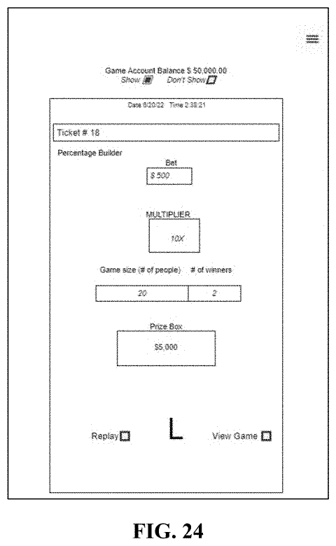

FIG. 24 represents the Percentage Builder Played Ticket Webpage. This webpage allows a player to view the variables of a Percentage Builder Cyber Ticket purchased that has participated in a Money Drop. This webpage allows a player to view the Percentage Builder Cyber Gameboard (game) of the Percentage Builder Cyber Ticket and/or repurchase a Percentage Builder Cyber Ticket with the same variables.

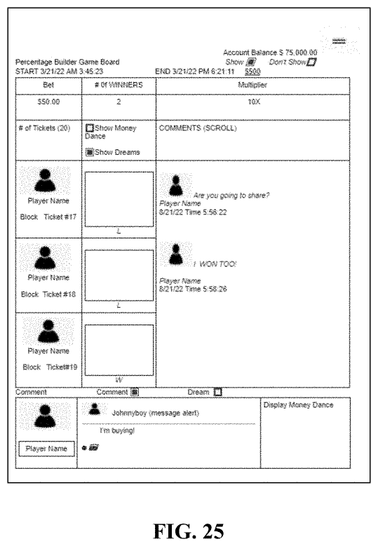

FIG. 25 represents the Percentage Builder Gameboard Comments Webpage. This webpage allows players to view all the players in a specific Percentage Builder betting pool. Players can communicate with the players, block communication with other players, show Money Drop results, and display a victory dance or ads entered by category on the Percentage Builder Cyber Gameboard Dreams Webpage.

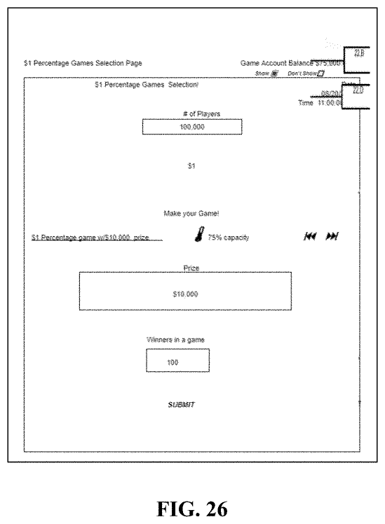

FIG. 26 represents the Set Pot Percentage game Selection Webpage. This webpage allows a player to view the prizes and odds per Cyber Ticket of the Set Pot Percentage game betting pools they want to purchase a Cyber Ticket in for $1 per Cyber Ticket. On this webpage a player will be able to view the capacity of the betting pool before purchasing the Cyber Ticket.

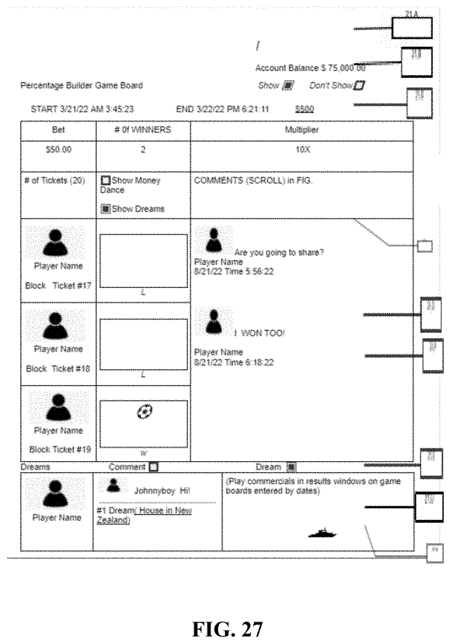

FIG. 27 represents the Percentage Builder Gameboard Dreams Webpage. This webpage allows players to view all the players in a specific Percentage Builder betting pool. On this webpage players can receive messages and comments from players, display ads, block communication with other players, show Money Drop results, enter a #1 Dream Entry to receive ads to display.

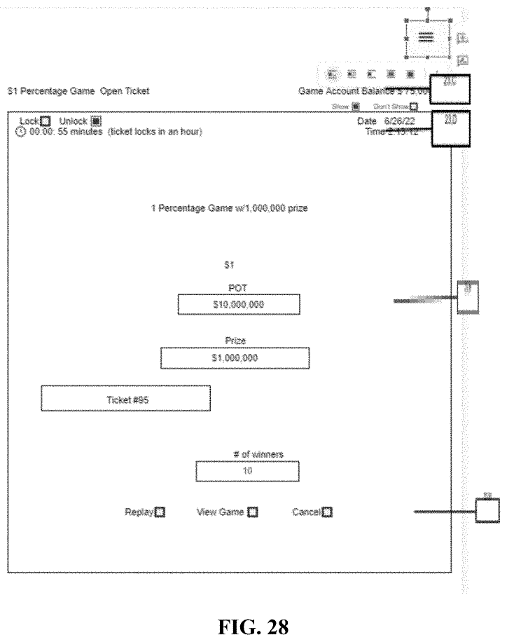

FIG. 28 represents the Set Pot Percentage game Open Ticket Webpage. This webpage permits a player to view the status and variables of a purchased Set Pot Percentage game Cyber Ticket that has NOT participated in a Money Drop. This webpage allows a player to view the gameboard of the Set Pot Percentage game Cyber Ticket, repurchase a Set Pot Percentage game Cyber Ticket with the same variables, and/or cancel the Set Pot Percentage game Cyber Ticket.

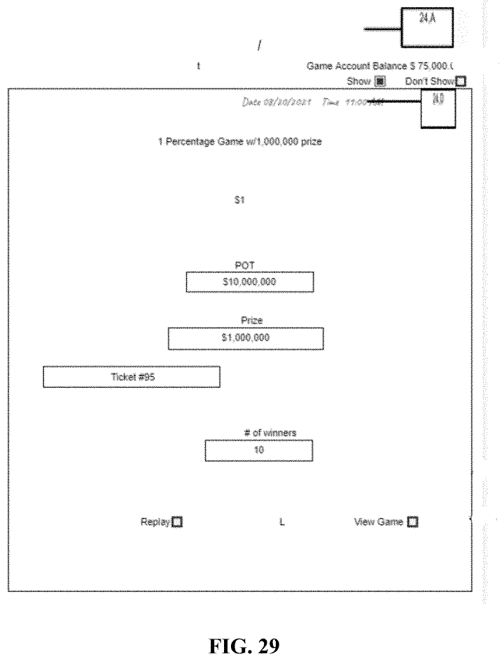

FIG. 29 represents the Set Pot Percentage game Played Ticket Webpage. This webpage permits a player to view the variables of a purchased Set Pot Percentage game Cyber Ticket that has participated in a Money Drop. This webpage allows a player to view the gameboard containing the Set Pot Percentage game Cyber Ticket and/or repurchase a Set Pot Percentage game Cyber Ticket with the same variables.

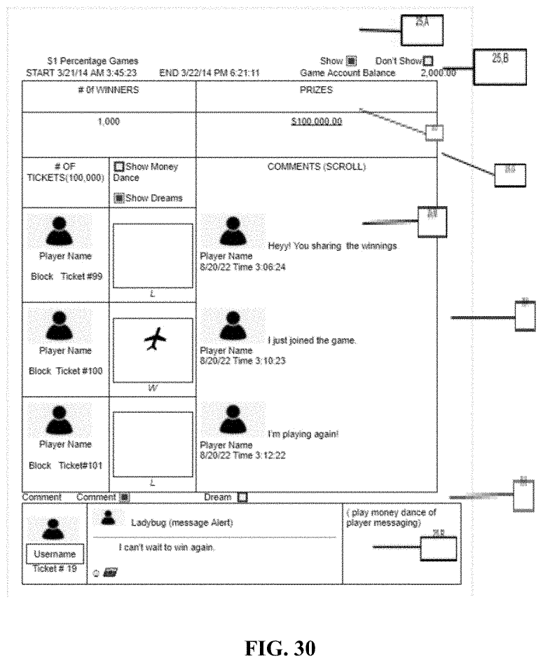

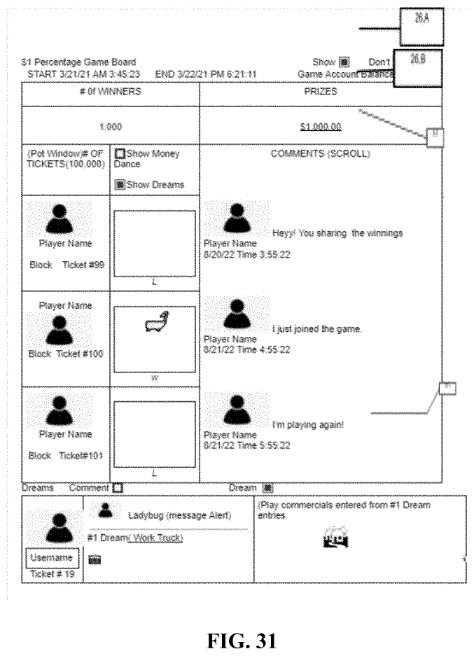

FIG. 30 represents the Set Pot Percentage gameboard Comments Webpage. This webpage allows players to view all the players in a specific Set Pot Percentage game betting pool. Players can communicate with the players, block communication with other players, show Money Drop results, and display a victory dance or ads entered by category on the Set Pot Percentage gameboard Dreams Webpage, represented in FIG. 31.

FIG. 31 represents the Set Pot Percentage gameboard Dreams Webpage. This webpage allows players to view all the players in a specific Set Pot Percentage game betting pool. On this webpage players can receive messages and comments from players, display ads, block communication with other players, show Money Drop results, enter a #1 Dream Entry to receive ads to display.

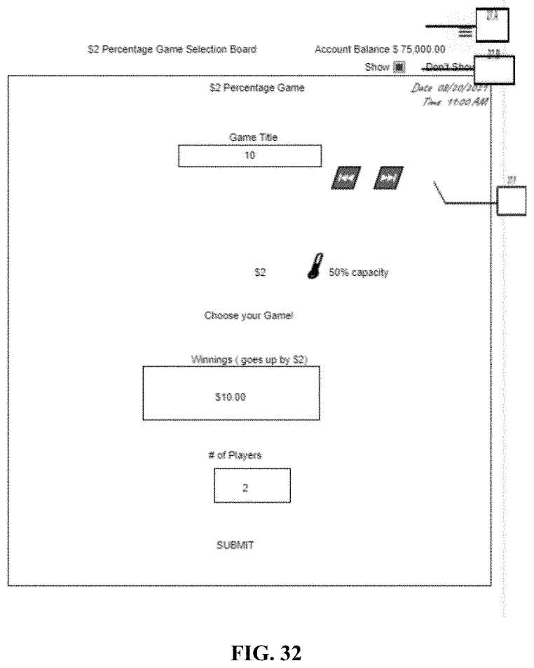

FIG. 32 represents the High Risk High Reward percentage game Selection Webpage. This webpage was designed to allow a player to view the prizes and odds of various betting pools with only two winners and each Cyber Ticket costing $2. On this webpage a player can view the capacity of the betting pools available and purchase a High Risk High Reward percentage game Cyber Ticket.

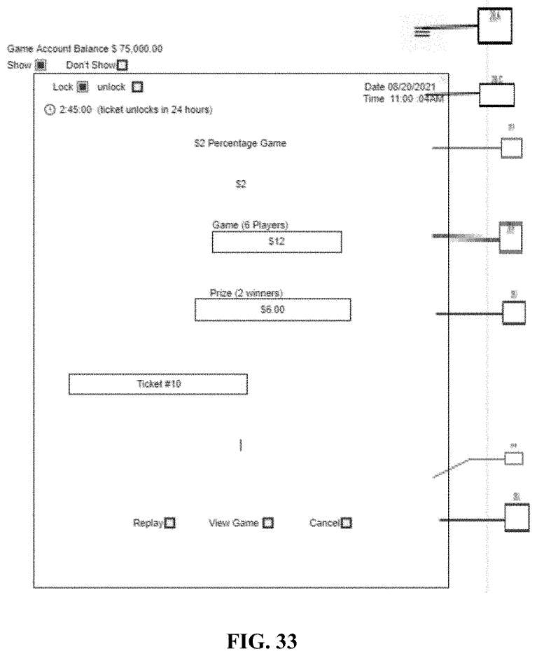

FIG. 33 represents the High Risk High Reward percentage game Open Ticket Webpage. This webpage was created to allow a player to view the status and variables of a High Risk High Reward percentage game Cyber Ticket that is currently in a gameboard that has not participated in a Money Drop. This webpage allows a player to view the gameboard of the High Risk High Reward percentage game Cyber Ticket, repurchase a High Risk High Reward percentage game Cyber Ticket with the same variables, and/or cancel the High Risk High Reward percentage game Cyber Ticket.

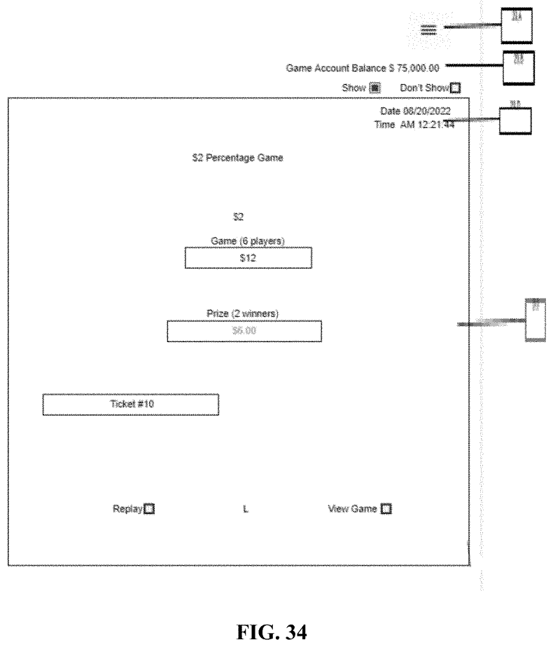

FIG. 34 represents the High Risk High Reward percentage game Played Ticket Webpage. This webpage was created to allow a player to view the variables of a purchased High Risk High Reward percentage game Cyber Ticket in a betting pool that has had a Money Drop. This webpage also allows a player to view the gameboard of the High Risk High Reward percentage game Cyber Ticket and/or repurchase a High Risk High Reward percentage game Cyber Ticket with the same variables.

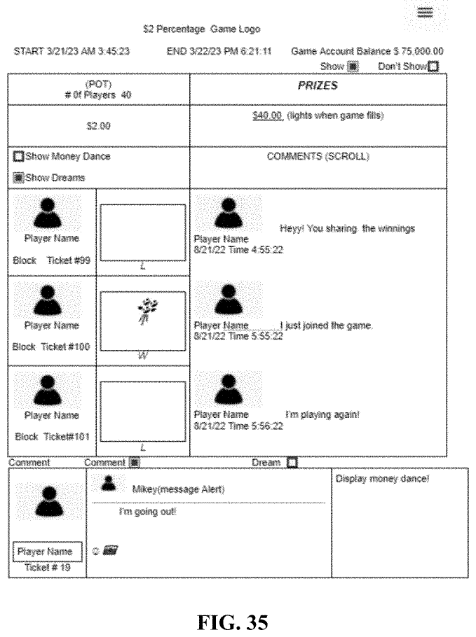

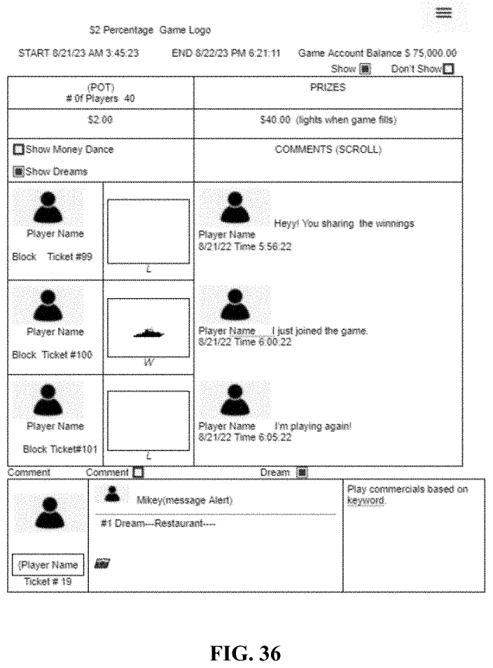

FIG. 35 represents the High Risk High Reward percentage gameboard Comment Webpage. This webpage allows players to view other players in a specific High Risk High Reward percentage gameboard. Players can communicate with the players, block communication with other players, show Money Drop results, and display a victory dance or ads entered by category on the High Risk High Reward percentage gameboard Dreams Webpage, represented in FIG. 36.

FIG. 36 represents the High Risk High Reward percentage gameboard Dreams Webpage. This webpage allows players to view other players in a specific High Risk High Reward percentage gameboard. On this webpage players can receive messages and comments from players, display ads, block communication with other players, show Money Drop results, enter a #1 Dream Entry to receive ads to display.

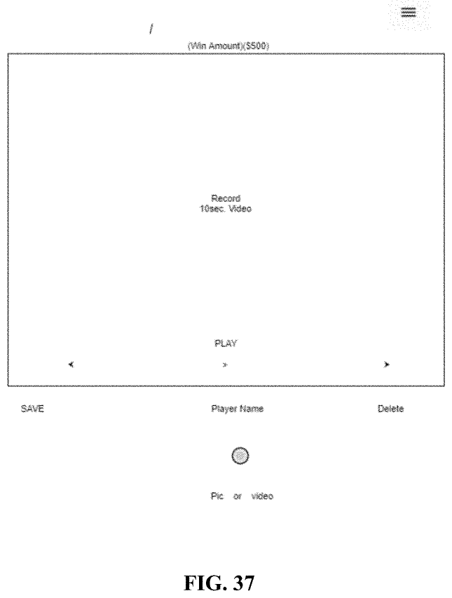

FIG. 37 represents the Dance Recorder Webpage. This webpage permits the player to record and save a victory dance called a Money Dance.

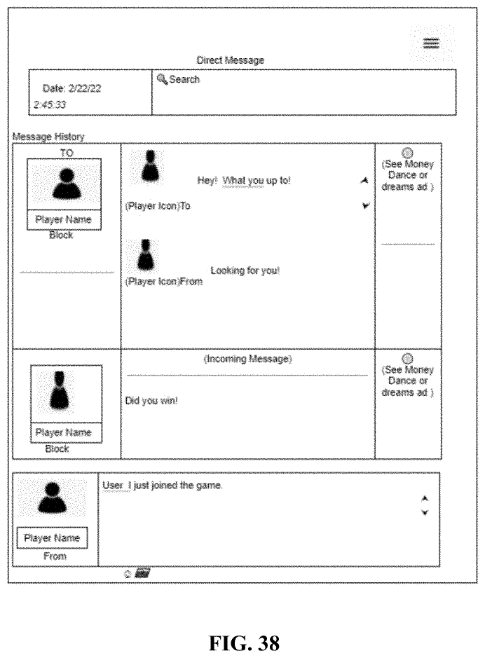

FIG. 38 represents the Direct message Webpage. This webpage allows two players to communicate privately between themselves and receive messages from other players.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A computer-implemented process of conducting a percentage-based lottery comprising the steps of:
providing a plurality of user electronic computing devices each of a plurality of users, respectively;
providing at least one server communicatively couplable to the plurality of user electronic computing devices over a network, with at least one computer processor, and with at least one non-transitory memory storing a plurality of user accounts thereon and each associated with one of the plurality of users, the at least one server operably configured to generate a plurality of user lottery pools each with varying defined limits of participants and with varying winning percentages associated therewith;
communicatively coupling the plurality of user electronic computing devices with the at least one server;
inputting, by the plurality of users:
user-identifying information;
a user-desired wagering amount into the electronic user interface of each of the plurality of user electronic computing devices, respectively;
a user-desired winning percentage, of one of the plurality of varying winning percentages, into the electronic user interface of each of the plurality of user electronic computing devices, respectively; and
a user-desired number of participants, of one of the varying defined limits of participants, into the electronic user interface of each of the plurality of user electronic computing devices, respectively;
generating at least one user lottery pool from the plurality of user lottery pools onto the electronic user interface of each of the plurality of user electronic computing devices, respectively, dictated by the user-desired wagering amount, the user-desired winning percentage, and the user-desired number of participants;
selecting the at least one user lottery pool from the plurality of user lottery pools by the plurality of users until reaching the user-desired number of participants associated with the at least one user lottery pool, wherein the reaching the user-desired number of participants associated with the at least one user lottery pool defines a triggering event; and
after reaching the triggering event, randomly selecting, by the at least one server, a number of lottery winners based on the user-desired winning percentage and awarding the number of lottery winners based on the user-desired wagering amount and the user-desired winning percentage.

2. The computer-implemented process according to claim 1, further comprising:
executing a software application on each of the plurality of user electronic computing devices and then, in a graphical user interface on the electronic user interface generated by the software application, inputting the user-desired wagering amount, the user-desired winning percentage, and the user-desired number of participants.

3. The computer-implemented process according to claim 2, further comprising:
inputting the user-desired wagering amount, the user-desired winning percentage, and the user-desired number of participants through a digital scrolling feature depicting, on the graphical user interface, the plurality of user lottery pools each with the varying defined limits of participants, the varying winning percentages associated therewith, and a plurality of desired wagering amounts associated therewith.

4. The computer-implemented process according to claim 1, further comprising:
selecting a plurality of user lottery pools from the plurality of user lottery pools by the plurality of users on the electronic user interface simultaneously.

5. The computer-implemented process according to claim 1, further comprising:
contributing a digital currency associated with and correlated to the user-desired wagering amount and the user-desired winning percentage to the at least one user account associated with the number of lottery winners.

6. The computer-implemented process according to claim 1, further comprising:
generating, in a graphical user interface on the electronic user interface, a capacity meter displaying the real time participants associated with the at least one user lottery pool.

7. The computer-implemented process according to claim 1, further comprising:
executing a software application on each of the plurality of user electronic computing devices and enabling communication between the plurality of user electronic computing devices selecting the at least one user lottery pool, through the software application, only up until reaching the triggering event.

8. A percentage-based lottery software application operably configured to be downloaded on a plurality of user electronic computing devices each of a plurality of users, respectively, and comprising:
computer-readable instructions programed to:
initiate a lottery gaming session on each of the respective plurality of user electronic computing devices;
receive, from each of the plurality of users in the lottery gaming session:
user-identifying information;
a user-desired wagering amount;
a user-desired winning percentage, of one of a plurality of varying winning percentages;
a user-desired number of participants, of one of a varying defined limits of participants; and
generate a graphical user interface in the lottery gaming session having a digital scrolling feature depicting the plurality of user lottery pools each with the varying defined limits of participants, the varying winning percentages associated therewith, and a plurality of desired wagering amounts associated therewith;
receive at least one user lottery pool from the plurality of user lottery pools onto an electronic user interface of each of the plurality of user electronic computing devices, respectively, dictated by the user-desired wagering amount, the user-desired winning percentage, and the user-desired number of participants;
receive, from each of the plurality of users, a selection of at least one user lottery pool from the plurality of user lottery pools until reaching the user-desired number of participants associated with the at least one user lottery pool, wherein the reaching the user-desired number of participants associated with the at least one user lottery pool defines a triggering event; and
randomly select, after reaching the triggering event, a number of lottery winners based on the user-desired winning percentage and award the number of lottery winners based on the user-desired wagering amount and the user-desired winning percentage.

9. The percentage-based lottery software application according to claim 8, further comprising:
computer-readable instructions programed to:
contribute a digital currency associated with and correlated to the user-desired wagering amount and the user-desired winning percentage to the at least one user account associated with the number of lottery winners.

10. The percentage-based lottery software application according to claim 8, further comprising:
computer-readable instructions programed to:
generate, in the graphical user interface on the electronic user interface, a capacity meter displaying the real time participants associated with the at least one user lottery pool.

11. The percentage-based lottery software application according to claim 8, further comprising:
computer-readable instructions programed to:
enable communication in the lottery gaming session between the plurality of user electronic computing devices selecting the at least one user lottery pool, through the software application, only up until reaching the triggering event.

12. At least one user electronic computing device with an executable percentage-based lottery software application resident thereon and operably configured to execute computer-readable instructions programed to:
initiate a lottery gaming session on each of the respective plurality of user electronic computing devices;
receive, from each of the plurality of users in the lottery gaming session:
user-identifying information;
a user-desired wagering amount;
a user-desired winning percentage, of one of a plurality of varying winning percentages;
a user-desired number of participants, of one of a varying defined limits of participants; and
generate a graphical user interface in the lottery gaming session having a digital scrolling feature depicting the plurality of user lottery pools each with the varying defined limits of participants, the varying winning percentages associated therewith, and a plurality of desired wagering amounts associated therewith;
receive at least one user lottery pool from the plurality of user lottery pools onto an electronic user interface of each of the plurality of user electronic computing devices, respectively, dictated by the user-desired wagering amount, the user-desired winning percentage, and the user-desired number of participants;
receive, from each of the plurality of users, a selection of at least one user lottery pool from the plurality of user lottery pools until reaching the user-desired number of participants associated with the at least one user lottery pool, wherein the reaching the user-desired number of participants associated with the at least one user lottery pool defines a triggering event; and
randomly select, after reaching the triggering event, a number of lottery winners based on the user-desired winning percentage and award the number of lottery winners based on the user-desired wagering amount and the user-desired winning percentage.

13. The electronic computing device according to claim 12, further operably configured to execute computer-readable instructions programed to:
contribute a digital current currency associated with and correlated to the user-desired wagering amount and the user-desired winning percentage to the at least one user account associated with the number of lottery winners.

14. The electronic computing device according to claim 12, further operably configured to execute computer-readable instructions programed to:
generate, in the graphical user interface on the electronic user interface, a capacity meter displaying the real time participants associated with the at least one user lottery pool.

15. The electronic computing device according to claim 12, further operably configured to execute computer-readable instructions programed to:
enable communication in the lottery gaming session between the plurality of user electronic computing devices selecting the at least one user lottery pool, through the software application, only up until reaching the triggering event.
